(19) United States
(12) Patent Application Publication
(10) Pub. No.: US 2026/0310469 A1
(43) Pub. Date: Oct. 8, 2026

(54) METHOD OF BOOTING AN NFC DEVICE

(71) Applicant: STMicroelectronics International N.V., Geneva (CH)

(72) Inventors: Pascal NONIER, Saint-Ismier (FR); Julien MERCIER, Mimet (FR)

(73) Assignee: STMicroelectronics International N.V., Geneva (CH)

(21) Appl. No.: 19/637,310

(22) Filed: Apr. 2, 2026

(30) Foreign Application Priority Data
Apr. 4, 2025 (FR) FR2503574

(51) Int. Cl. G06F 9/4401

(52) U.S. Cl. CPC G06F 9/4401

(57) ABSTRACT

This disclosure relates to a near field communication device powered by a radio frequency field, the NFC device including a boot control circuit configured to control, during a boot phase, the booting of the NFC device in response to the detection of an RF field, and a measuring circuit configured to estimate, during the boot phase, the strength of the RF field. The boot control circuit is further configured to adjust, during the boot phase, a voltage limitation level, a frequency level and/or a voltage supply level of one or more circuits of the NFC device, based on the estimated RF field strength, in order to modify the duration of the boot phase.

### PRIORITY CLAIM

This application claims the priority benefit of French Application for Patent No. FR2503574, filed on Apr. 4, 2025, the content of which is hereby incorporated by reference in its entirety to the maximum extent allowable by law.

### TECHNICAL FIELD

The present disclosure relates generally to near field communications (NFC) and, more particularly, to the booting of an NFC device following the detection of a radio frequency (RF) field.

### BACKGROUND

NFC communication is a technology that allows wireless data exchange between a reader device and a receiver device, usually referred to as an NFC card device. The reader device sends a polling request (known as polling), and an NFC card device present in the field responds to the request in order to establish an NFC communication.

The NFC card device is generally battery-free and is powered by the RF field. In order to respond to a polling request, the NFC card device enters a boot phase powered by energy recovered from the RF field, for example in the form of an electric current. The level, or intensity, of this current depends on the field strength received by the NFC card device, which in turn depends on the field strength emitted by the reader device and on the distance separating the NFC card device from the reader device.

The speed of the boot phase of an NFC card device is directly related to the power consumption of the circuits that make up the device. Configuring these circuits to have a high power consumption ensures a high booting speed, but presents a risk of boot failure in the event of insufficient energy supplied by the field. Conversely, selecting these circuits to have a low power consumption reduces the risk of insufficient current during the boot phase, but increases the duration of the boot phase, which may prevent communication between the NFC card device and the reader device. Indeed, in order for the response of an NFC card device to be detected by the reader device and for an NFC communication to be established, the response delay of the NFC card device should be sufficiently low so as not to exceed the delay imposed by the reader device, which is, for example, generally of the order of 5 milliseconds (a value defined by the ISO14443 standard), but may be lower in certain cases.

There is a need to make the booting behavior of NFC devices controllable with regard to the properties of the emitted radio frequency field.

### SUMMARY

According to an embodiment, there is provided a near field communication device powered by an RF field, the NFC device comprising a boot control circuit configured to control, during a boot phase, the booting of the NFC device in response to the detection of an RF field, and a measuring circuit configured to estimate, during the boot phase, the strength of the RF field, wherein the boot control circuit is further configured to adjust, during the boot phase, a voltage limitation level, a frequency level, and/or a voltage supply level of one or more circuits of the NFC device, based on the estimated RF field strength, in order to modify the duration of the boot phase.

According to an embodiment, the boot control circuit is further configured to initialize, at the start of the boot phase, the voltage limitation level, the frequency level, and/or the voltage supply level to initial values.

According to an embodiment, the NFC device further comprises one or more voltage limiting circuits configured to apply the voltage limitation level, and the boot control circuit is configured to adjust the voltage limitation level by controlling the one or more voltage limiting circuits.

According to an embodiment, the NFC device further comprises a clock generator comprising an oscillator and configured to generate a clock signal, and the boot control circuit is configured to adjust the frequency level of the clock signal during the boot phase in order to modify the duration of the boot phase.

According to an embodiment, the boot control circuit is configured to deactivate the oscillator during the RF field strength estimation.

According to an embodiment, the NFC device further comprises a memory clocked by the clock signal.

According to an embodiment, the NFC device further comprises a voltage regulator configured to impose a supply voltage on the one or more circuits, the boot control circuit being configured to adjust the supply voltage level by controlling the voltage regulator in order to modify the duration of the boot phase.

According to an embodiment, the NFC device further comprises an antenna, wherein the boot control circuit is configured to modify an antenna quality factor based on the estimated RF field strength.

Another embodiment provides an NFC communication system comprising the NFC device as described above and a reader device configured to emit the RF field.

Another embodiment provides a method of booting a near field communication device powered by an RF field, the method comprising controlling, by an NFC devicea boot control circuit, during a boot phase, the booting of the NFC device in response to the detection of an RF field, estimating, by a measuring circuit, during the boot phase, the strength of the RF field, and adjusting, by the boot control circuit, during the boot phase, a voltage limitation level, a frequency level, and/or a power supply level of one or more circuits of the NFC device based on the estimated RF field strength, in order to modify the duration of the boot phase.

According to an embodiment, the method further comprises initializing, by the boot control circuit, at the start of the boot phase, the voltage limitation level, the frequency level, and/or the power supply level to initial values.

According to an embodiment, the method further comprises applying the voltage limitation level using one or more voltage limiting circuits.

According to an embodiment, the method further comprises generating, by a clock generator comprising an oscillator, a clock signal, and adjusting, by the boot control circuit, the frequency level of the clock signal during the boot phase in order to modify the duration of the boot phase.

According to an embodiment, the method further comprises deactivating, by the boot control circuit, the oscillator during the RF field strength estimation.

According to an embodiment, the method further comprises modifying, by the boot control circuit, a quality factor of an antenna of the NFC device based on the estimated RF field strength.

### BRIEF DESCRIPTION OF THE DRAWINGS

The foregoing features and advantages, as well as others, will be described in detail in the following description of specific embodiments given by way of illustration and not limitation with reference to the accompanying drawings, in which:

FIG. 1 illustrates schematically an NFC communication system comprising an NFC reader device and an NFC card device according to an embodiment of the present application.

FIG. 2 is a flowchart illustrating a process for booting the NFC card device of FIG. 1 according to an embodiment of the present application.

FIG. 3 is a flowchart illustrating the steps of FIG. 2 in more detail.

FIG. 4 is a flowchart illustrating, in more detail, the steps of the method of FIGS. 2 and 3.

### DETAILED DESCRIPTION

Like features have been designated by like references in the various figures. In particular, the structural and/or functional features that are common among the various embodiments may have the same references and may dispose identical structural, dimensional and material properties.

For the sake of clarity, only the operations and elements that are useful for an understanding of the embodiments described herein have been illustrated and described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, unless indicated otherwise, when reference is made to absolute positional qualifiers, such as the terms “front”, “back”, “top”, “bottom”, “left”, “right”, etc., or to relative positional qualifiers, such as the terms “above”, “below”, “higher”, “lower”, etc., or to qualifiers of orientation, such as “horizontal”, “vertical”, etc., reference is made to the orientation shown in the figures.

Unless specified otherwise, the expressions “around”, “approximately”, “substantially” and “in the order of” signify within 10 % or 10°, and preferably within 5 % or 5°.

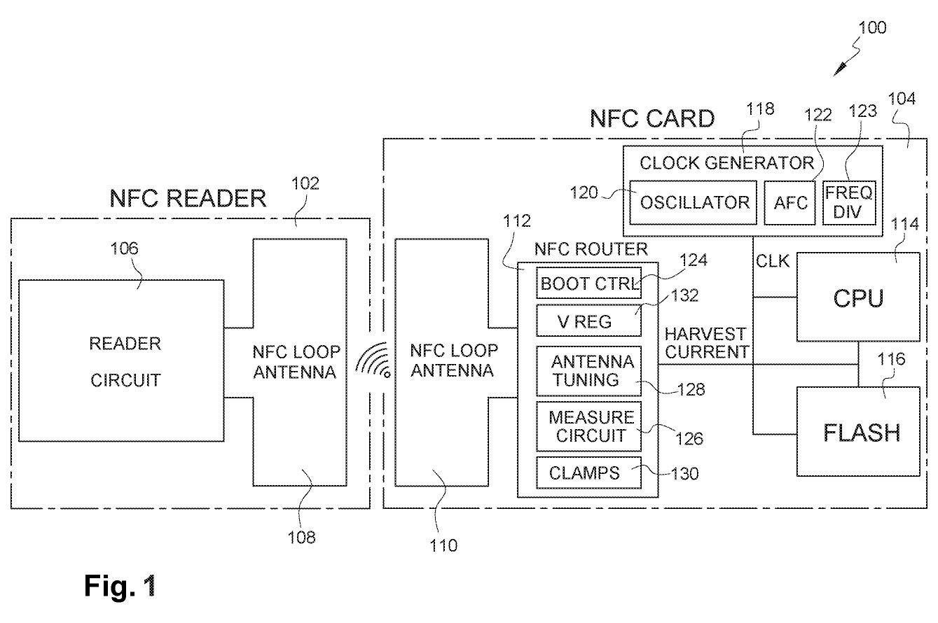

FIG. 1 illustrates schematically an NFC reader device (NFC READER) 102 and an NFC card device (NFC CARD) 104 according to an embodiment of the present application.

The NFC reader device 102 comprises a reader circuit 106 (READER CIRCUIT) and a loop antenna 108 (NFC LOOP ANTENNA).

The NFC card device 104 is, for example, a contactless card powered at least partially, and in some cases entirely, by energy recovered from the RF field emitted by the reader device 102. In some cases, the NFC card device 104 does not include a battery to power its circuitry. The NFC card device 104 is, for example, compatible with the ISO14443 standard and/or the ISO18092 standard.

The NFC card device 104 includes, for example, a loop antenna 110 (NFC LOOP ANTENNA) supplying a signal to a routing circuit 112 (NFC ROUTER).

The routing circuit 112 is configured, for example, to extract a current (HARVEST CURRENT) induced by the field and to supply this current to a processor 114 (CPU) and a memory 116 (FLASH). The processor 114 is a Central Processing Unit. The processor 114 is clocked, for example, by a clock signal CLK generated by a clock generator (CLOCK GENERATOR) 118 comprising, for example, an oscillator (OSCILLATOR) 120, an automatic frequency control circuit (AFC) 122 and a frequency divider (FREQ DIV) 123.

The memory 116 is, for example, a non-volatile memory such as a flash memory.

The oscillator 120 is configured, for example, to generate a signal at a first frequency, such as 60 MHz.

The frequency divider 123 is configured to selectively divide the frequency of the signal generated by the oscillator 120. For example, for a 60 MHz oscillator signal, the frequency divider 123 is capable of generating a signal with a frequency of 60 MHz, 30 MHz, or 15 MHz by applying a division factor of 1, 2, or 4.

The routing circuit 112 includes, for example, a boot control circuit 124 (BOOT CTRL) configured to control a boot phase of the NFC card device 104 in response to the detection of an RF field emitted by the NFC reader device 102 via the antenna 110 of the NFC card device 104. The boot control circuit 124 may be implemented, for example, by a finite state machine. The routing circuit 112 further comprises a measuring circuit 126 (MEASURE CIRCUIT) configured to measure, during the boot phase, the RF field strength received via the antenna 110. The routing circuit 112 further comprises an antenna tuning circuit 128 (ANTENNA TUNING) configured to tune parameters of the antenna 110. The routing circuit 112 further comprises one or more voltage limiting circuits 130 (CLAMPS) configured to limit the voltage of the electronic signal recovered from the RF field in order to avoid overvoltages in the event of a strong RF field that could damage the circuitry of the NFC card device 104. The routing circuit 112 further comprises a voltage regulator 132 (V REG) configured to generate a supply voltage for one or more circuits of the NFC card device 104. The voltage regulator 132 imposes, for example, a voltage on the conductor supplying the current recovered from the RF field to the processor 114 and the memory 116.

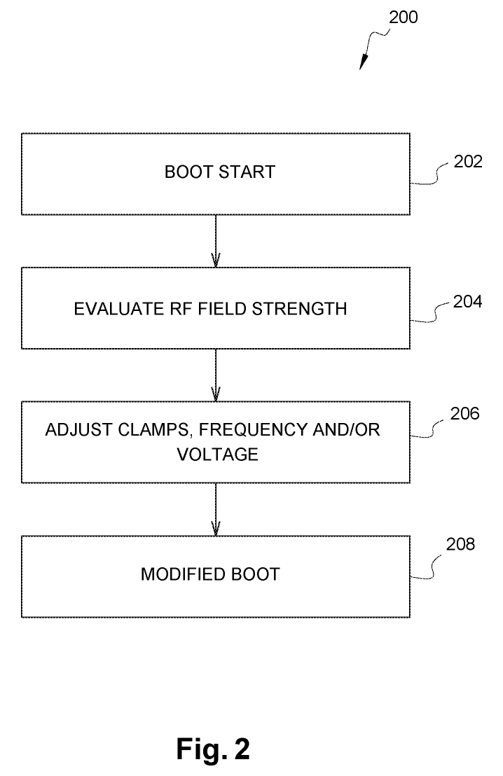

FIG. 2 is a flowchart illustrating a boot process 200 for the NFC card device 104 of FIG. 1 according to an embodiment of the present application. FIG. 2 illustrates an example of a boot control process implemented by the boot control circuit 124 of FIG. 1.

In a boot start step 202 (BOOT START),, the boot control circuit 124 initializes a boot phase of the NFC card device 104. For example, the clock generator 118 initializes the frequency of the clock signal generated by the oscillator 120 to a relatively low level, such as 15 MHz.

In an RF field strength evaluation step 204 (EVALUATE RF FIELD STRENGTH),, the boot control circuit 124 evaluates the RF field strength captured by the antenna 110 of the NFC card device 104. For example, the boot control circuit 124 detects a level of electric current or voltage recovered from the RF field via the antenna 110.

In a step 206 (ADJUST CLAMPS, FREQUENCY AND/OR VOLTAGE), the boot control circuit 124 is configured to adjust a voltage limitation level, an operating frequency and/or a supply voltage of one or more circuits of the NFC card device 104 based on the detected RF field strength and in order to modify the boot duration of the NFC card device 104. For example, in the case where the detected RF field strength is relatively high, the boot control circuit 124 is configured to select the voltage limitation level, the operating frequency and/or the supply voltage of one or more circuits of the NFC card device 104 so as to target a relatively low boot duration, for example less than 3 ms, and for example less than 2 ms. On the contrary, in the case where the detected strength of the RF field is relatively low, the boot control circuit 124 is configured to select the voltage limitation level, the operating frequency and/or the supply voltage of one or more circuits of the NFC card device 104 so as to target a relatively long boot duration, for example greater than 3 ms, and for example greater than 4 ms.

In a step 208 (MODIFIED BOOT), the modified boot step, the boot control circuit 124 continues the boot phase of the NFC card device 104 using the selected parameter levels to modify the duration of the boot phase.

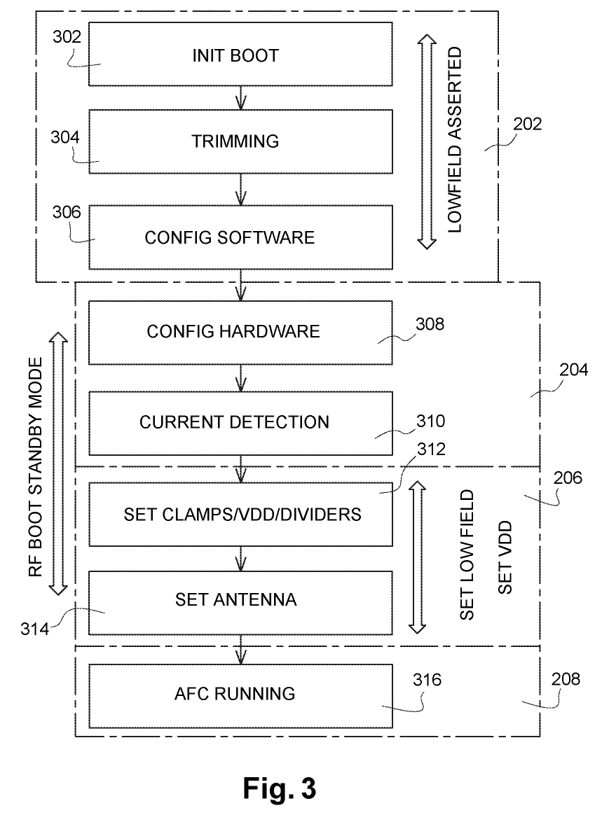

FIG. 3 is a flowchart illustrating the steps of FIG. 2 in more detail.

The boot start step 202 of FIG. 2 comprises steps 302, 304 and 306.

During the initialization step 302 (INIT BOOT),, the boot control circuit 124 sets system boot parameters, such as the frequency of the clock signal generated by the clock generator 118 and, in some cases, a modulation ratio applied to the signal generated by the oscillator 120 or by the frequency divider 123. In some cases, the clock generator 118 comprises a modulation circuit configured to modulate the frequency of the signal generated by the oscillator 120 based on the modulation ratio set by the boot control circuit 124. The modulation ratio may be represented as a percentage of the oscillator frequency with a granularity of, for example, 5 percent. During this initialization step, the booting parameters are for example selected to ensure a low power consumption of the NFC card device 104 during a first part of the boot phase, for example during the steps 302, 304 and 306. For example, as indicated by the reference "LOW FIELD ASSERTED", a low field parameter is for example activated, implying that the boot parameters are those chosen to suit a low power field, and a low power mode of the NFC card device 104 is therefore selected.

During the trimming step 304 (TRIMMING),, the boot control circuit 124 calibrates one or more internal components of the NFC card device 104, for example the processor 114 and/or the routing circuit 112, based on calibration parameters stored in the memory 116. These calibration parameters are loaded into registers and used to adjust component characteristics such as supply voltage levels and transistor bias voltages.

During the software configuration step 306 (CONFIG SOFTWARE),, the boot control circuit 124 retrieves configuration data from the memory 116 for certain circuits, such as the antenna tuning circuit 128 and/or the automatic frequency control circuit AFC 122, in order to prepare these circuits for subsequent operation.

The RF field strength evaluation step 204 of FIG. 2 comprises steps 308 hardware configuration and 310 current detection steps.

During the hardware configuration step 308 (CONFIG HARDWARE),, the boot control circuit 124 initializes the measuring circuit 126. One or more analog circuits of the measuring circuit 126 are activated during this step. In addition, the boot control circuit 124 is configured, for example, to place the NFC card device 104 in a low power state, in order to limit noise during the field strength measurement. For example, the processor 114 and/or the clock generator 118 are deactivated. If the clock generator 118 is deactivated, the boot control circuit 124 is clocked, for example, by a clock signal retrieved from the received RF field that is, for example, at a frequency of 13.56 MHz.

During the current detection and clamp setting step 310 (CURRENT DETECTION AND CLAMP SETTING),, the measuring circuit 126 measures the RF field strength during the boot phase, for example when the NFC card device 104 is in the low power state. The field strength may be measured by measuring the level of electric current recovered via the antenna 110. The routing circuit 112 may comprise one or more circuits configured to convert an alternating current (AC) electrical signal received by the antenna 110 into a direct current (DC),, and the measuring circuit 126 measures the level of this DC current. In some cases, the routing circuit 112 also comprises a voltage regulator configured to provide the processor 114 and the memory 116 with a stable supply voltage derived from the generated DC current.

In some cases, the field strength assessment is performed by activating, one after the other, the voltage limiting circuits 130, starting with the voltage limiting circuit with the highest voltage and moving towards the voltage limiting circuit with the lowest voltage. Each voltage limiting circuit 130 is configured to impose a voltage level corresponding, for example, to 4.2 V, 3.1 V, 2.6 V and 2.3 V. For example, the boot control circuit 124 is configured to initialize the voltage limiting circuits 130 to a voltage equal to 4.2 V, to measure the level of the recovered electric current and to compare this level with a first threshold. If the measured current is equal to or greater than the first threshold, the boot control circuit 124 is configured, for example, to retain the selection of the limiting voltage at 4.2 V and to proceed to a subsequent step 312. If, on the other hand, the measured current is lower than the first threshold, the boot control circuit 124 is configured, for example, to decrease the voltage of the voltage limiting circuits 130 by one step, for example to the level of 3.1 V, to measure the level of the recovered electric current, to compare this level with a second threshold lower than the first threshold, and depending on the comparison, to retain the limiting voltage at 3.1 V or to decrease the voltage of the voltage limiting circuits 130 by one step. The boot control circuit 124 repeats this process until it obtains the configuration of the voltage limiting circuits 130 that avoids overvoltages or overcurrents that can damage circuitry on the NFC card device 104, while selecting a lower limiting voltage to reduce losses and to increase the energy recovered from the field.

During the clamp, supply voltage, and divider setting step 312 (SET CLAMP/VDD/DIVIDERS),, the boot control circuit 124 adjusts the voltage limitation level, the frequency level, and/or the supply voltage level of one or more circuits of the NFC card device 104, such as the processor 114 and the memory 116, based on the estimated RF field strength.

For example, the boot control circuit 124 determines an RAC (RF Available Current) parameter in the form of a combination of binary states defining several possible power consumption levels of the NFC card device 104. For example, the RAC parameter can take four values: "00", "01", "10" and "11".

For example, the boot control circuit 124 is configured to impose a supply voltage on one or more circuits of the NFC card device 104, for example by controlling the voltage regulator 132. According to an example, the imposed voltage is equal to 0.9 V if the RAC parameter value is "00", is equal to 1 V if the RAC parameter value is "01", is equal to 1.1 V if the RAC parameter value is "10" and is equal to 1.2 V if the RAC parameter value is "11".

In addition, the boot control circuit 124 is configured, for example, to select the voltage limiting level applied by the one or more voltage limiting circuits 130, based on the RAC parameter. For example, the voltage imposed by the voltage limiting circuit for an RAC value of "00" is 2.3 V, the voltage imposed by the voltage limiting circuit for an RAC value of "01" is 2.6 V, the voltage imposed by the voltage limiting circuit for an RAC value of "10" is 3.2 V and the voltage imposed by the voltage limiting circuit for an RAC value of "11" is 4.2 V.

In addition, the frequency divider 130 is configured, for example, to select the division level based on the RAC parameter value. For example, in the case where the oscillator 120 generates a signal at a frequency of 60 MHz, an RAC value "00" is associated with a division of the frequency of the clock signal by 4, and therefore generates a frequency of 15 MHz, an RAC value "01" is associated with a division of the frequency of the clock signal by 2, and therefore generates a frequency of 30 MHz, an RAC value "10" or "11" is not associated with a division of the frequency of the clock signal, and therefore retains a frequency of 60 MHz.

In addition, the low field parameter is for example set (SET LOW FIELD) to an activation level, for example to "1", for an RAC value of "00", implying for example the configuration of the NFC card device in the low power mode. The low field parameter is for example set to a deactivation level, for example to "0", for an RAC value other than "00", implying for example the configuration of the NFC card device in a normal power consumption mode.

During this step, the boot control circuit 124 may also set parameters for the non-volatile memory 116 and for the voltage regulator of the routing circuit depending on the estimated field strength.

In a step 314 (SET ANTENNA), the antenna control circuit 128 is configured to improve one or more transmission parameters of the antenna 110, for example by decreasing or increasing its quality factor. Indeed, when the estimated field strength is greater than the capabilities of the NFC card device 104, the boot control circuit 124 is configured to control the quality factor in order to dissipate this excess energy. Conversely, when the estimated field strength is low, the quality factor of the antenna 110 should be increased to increase the energy recovered from the field.

During the steps 308, 310, 312 and 314, the boot control circuit 124 is configured, for example, to place the NFC card device 104 in a standby mode of the RF boot phase (RF BOOT STANDBY MODE).

In a step 316 (AFC RUNNING), the boot control circuit 124 is configured, for example, to continue the boot phase of the NFC card device 104 and to generate a response to the polling request. In particular, the boot control circuit 124 is configured, for example, to remove the NFC card device 104 from the low power mode, for example by reactivating the processor 114, the clock generator 118 and the automatic frequency control circuit 122. The booting of the NFC card device 104 continues with parameters selected as described above in order to reduce the boot duration depending on the estimated field strength, thus making it possible to reduce the boot duration when the field strength permits it.

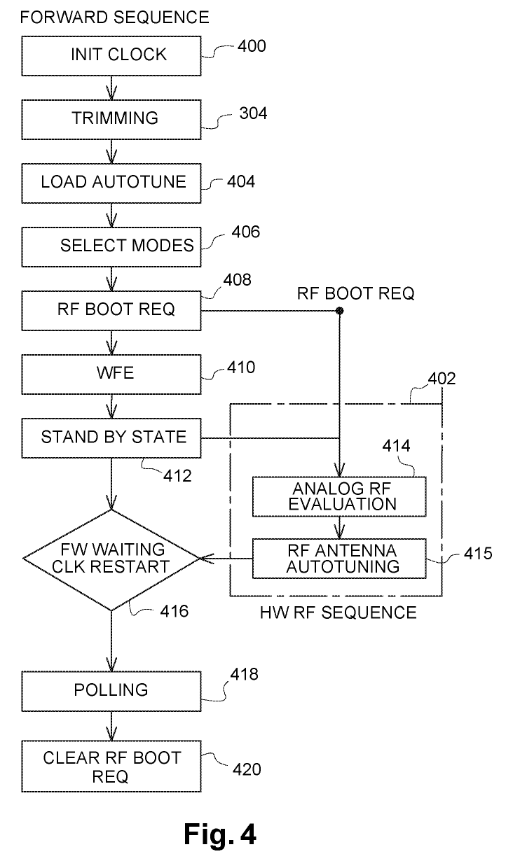

FIG. 4 is a flowchart illustrating, in more detail, the steps of the method of FIGS. 2 and 3. In particular, FIG. 4 illustrates in detail a main sequence 400 (FORWARD SEQUENCE) carried out, for example, when the processor 114 is activated, and a hardware RF sequence 402 (HW RF SEQUENCE) carried out when the processor 114 is deactivated and is for example in the standby mode.

In a step 400 (INIT CLOCK), the clock generator 118 is configured, for example, to initialize the frequency divider 123 with a division factor equal to 4, and therefore a frequency of 15 MHz if the oscillator 120 operates at 60 MHz. In addition, the modulation ratio is, for example, set by the clock generator 118 to 7.5%, which produces a clock signal at a frequency equal to 1.125 MHz. This is a clock signal generation action performed during the initialization step 302 of the boot control circuit 124, as indicated in relation with the description of FIG. 3.

After the step 400, the step 304 (TRIMMING) is carried out, for example, as described in relation to FIG. 3. In this step, the boot control circuit 124 is configured to calibrate one or more internal components of the NFC card device 104, for example the processor 114 or the routing circuit 112, based on calibration parameters stored in the memory 116.

In a step 404 (LOAD AUTOTUNE) after the step 304, the operations of the step 306 of FIG. 3 are for example carried out and in some cases, the boot control circuit 124 is configured to carry out a total or partial adaptation of the tuning of the antenna 110 according to its size.

In a step 406 (SELECT MODES) after the step 404, the boot control device 124 is configured, for example, to select one of the operating modes of the NFC card device 104, i.e. with a contact between the reader device 102 and the NFC card device 104, or without. The boot control circuit 124 is configured, for example, to store one or more RF parameters as well as the RAC parameter and the voltage values of the voltage limiting circuits, as shown in the step 310 of FIG. 3, within the memory 116.

In a step 408 (RF BOOT REQ), after the step 406, an RF BOOT REQ command is activated, for example with the value "1".

After the step 408, the process continues with the launch of the hardware RF sequence 402 and a step 410 (WFE) in which the processor 114 is configured to wait for an event (WAIT FOR EVENT or WFE), then enter a standby mode in a step 412 (STANDBY STATE).

The sequence 402 includes an RF field evaluation step 414 (ANALOG RF EVALUATION) based on measurements from analog circuits, which comprises the step 310 of FIG. 3. It further comprises an antenna parameter calibration step (RF ANTENNA AUTOTUNING) 415, which comprises the step 314 of FIG. 3.

In a step 416 (FW WAITING CLK RESTART) after the step 415, the boot control circuit 124 is configured, for example, to control a delay step waiting for the completion of the sequence 402 and of the step 412.

In a step 418 (POLLING), the boot control circuit 124 is configured, for example, to continue the boot phase and the generation of a response to the polling request from the NFC reader device 102, with the parameters regulated by the previous actions.

In a step 420 (CLEAR RF BOOT REQ) after the step 418, the boot control circuit 124 is configured, for example, to clear the RF BOOT REQ parameter value assigned in the step 408.

Finally, the RF boot request signal is cleared.

An advantage of the described embodiments is that the boot time of an NFC card device can be adjusted based on the detected RF field strength, thereby reducing the response time to a polling request.

Various embodiments and variants have been described. Those skilled in the art will understand that certain features of these embodiments can be combined and other variants will readily occur to those skilled in the art. In particular, although the embodiments have been described based on an NFC card, more generally, the described principles could be applied to any NFC device powered by an RF field.

Finally, the practical implementation of the embodiments and variants described herein is within the capabilities of those skilled in the art based on the functional description provided hereinabove.

1. A near field communication (NFC) device powered by a radio frequency field, the NFC device comprising:
a boot control circuit configured to control, during a boot phase, booting of the NFC device in response to detection of an RF field; and
a measuring circuit configured to estimate, during the boot phase, strength of the RF field, wherein the boot control circuit is further configured to adjust, during the boot phase, a voltage limitation level, a frequency level and/or a voltage supply level of one or more circuits of the NFC device, based on the estimated RF field strength, in order to modify duration of the boot phase.

2. The NFC device according to claim 1, wherein the boot control circuit is further configured to initialize, at a start of the boot phase, the voltage limitation level, the frequency level and/or the voltage supply level to initial values.

3. The NFC device according to claim 1, further comprising one or more voltage limiting circuits configured to apply the voltage limitation level, and wherein the boot control circuit is configured to adjust the voltage limitation level by controlling the one or more voltage limiting circuits.

4. The NFC device according to claim 1, further comprising a clock generator comprising an oscillator and configured to generate a clock signal, and wherein the boot control circuit is configured to adjust the frequency level of the clock signal during the boot phase in order to modify the duration of the boot phase.

5. The NFC device according to claim 4, wherein the boot control circuit is configured to deactivate the oscillator during the RF field strength estimation.

6. The NFC device according to claim 4, further comprising a memory clocked by the clock signal.

7. The NFC device according to claim 1, further comprising a voltage regulator configured to impose a supply voltage on the one or more circuits, wherein the boot control circuit is configured to adjust a level of the supply voltage by controlling the voltage regulator in order to modify the duration of the boot phase.

8. The NFC device according to claim 1, further comprising an antenna, wherein the boot control circuit is configured to increase an antenna quality factor if the estimated RF field strength is below a threshold, and to decrease the antenna quality factor if the estimated RF field strength is above the threshold.

9. An NFC communication system, comprising:
a near field communication (NFC) device powered by a radio frequency field, the NFC device comprising:
boot control circuit configured to control, during a boot phase, booting of the NFC device in response to detection of an RF field; and
a measuring circuit configured to estimate, during the boot phase, strength of the RF field, wherein the boot control circuit is further configured to adjust, during the boot phase, a voltage limitation level, a frequency level and/or a voltage supply level of one or more circuits of the NFC device, based on the estimated RF field strength, in order to modify duration of the boot phase; and
a reader device configured to emit the RF field.

10. A method of booting a near field communication (NFC) device powered by a radio frequency field, the method comprising:
controlling, by a boot control circuit of the NFC device, during a boot phase, booting of the NFC device in response to detection of an RF field;
estimating, by a measuring circuit, during the boot phase, strength of the RF field; and
adjusting, by the boot control circuit, during the boot phase, a voltage limitation level, a frequency level and/or a power supply level of one or more circuits of the NFC device based on the estimated RF field strength, in order to modify a duration of the boot phase.

11. The method according to claim 10, further comprising initializing, by the boot control circuit at a start of the boot phase, a level of the voltage limitation level, the frequency level and/or the power supply level to initial values.

12. The method according to claim 10, wherein the NFC device further comprises one or more voltage limiting circuits configured to apply the voltage limitation level.

13. The method according to claim 10, further comprising:
generating, by a clock generator comprising an oscillator, a clock signal; and
adjusting, by the boot control circuit, the frequency level of the clock signal during the boot phase in order to modify a duration of the boot phase.

14. The method according to claim 13, further comprising deactivating, by the boot control circuit, the oscillator during the RF field strength estimation.

15. The method according to claim 10, further comprising increasing, by the boot control circuit, a quality factor of an antenna of the NFC device if the estimated RF field strength is below a threshold, and decreasing the antenna quality factor if the estimated RF field strength is above the threshold.
